(19) United States
(12) Patent Application Publication
(10) Pub. No.: US 2014/0012913 A1
(43) Pub. Date: Jan. 9, 2014

(54) Peer-Peer Device Activation and Setup

(71) Applicants: Devrim Varoglu, Santa Clara, CA (US); Swapnil R. Dave, Santa Clara, CA (US)

(72) Inventors: Devrim Varoglu, Santa Clara, CA (US); Swapnil R. Dave, Santa Clara, CA (US)

(21) Appl. No.: 13/611,042

(22) Filed: Sep. 12, 2012

Related U.S. Application Data
(60) Provisional application No. 61/668,266, filed on Jul. 5, 2012.

(51) Int. Cl. G06F 15/177; H04W 76/02

(52) U.S. Cl. 709/204

(57) ABSTRACT

Setting up a user equipment (UE) device via a peer-to-peer wireless link. A peer device may be discovered using a peer-to-peer wireless communication protocol. A peer-to-peer wireless link may be established with the peer device using the peer-to-peer wireless communication protocol. Device setup information for the UE may be requested from the peer device via the peer-to-peer wireless link. The device setup information may be received from the peer device via the peer-to-peer wireless link. The UE may be configured using the device setup information.

### PRIORITY CLAIM

The present application claims benefit of priority to U.S. Provisional Application No. 61/668,266 titled “Peer-Peer Device Activation and Setup” and filed on Jul. 5, 2012, whose inventors are Devrim Varoglu, and Swapnil R. Dave, and which is hereby incorporated by reference in its entirety as thought fully and completely set forth herein.

### FIELD

The present application relates to wireless devices, and more particularly to a system and method for activating and setting up a wireless device via a peer-to-peer link.

### DESCRIPTION OF THE RELATED ART

Wireless communication systems are rapidly growing in usage. Further, wireless communication technology has evolved from voice-only communications to also include the transmission of data, such as Internet and multimedia content.

When initially acquired, a wireless device may require some setup and/or activation. For example, some devices may require certain hardware drivers to be installed, system settings to be configured, etc., before the device may be fully functional. Alternatively, or in addition, a user may wish to transfer preferred user settings and/or programs (e.g., applications or “apps”, favorite settings within those apps, linked email or social networking accounts) to a new device. Additionally, some devices (e.g., those configured to perform cellular communications) may typically be required to be activated with a service provider before they are allowed to communicate with cellular base stations of the service provider's cellular network according to the terms of a service agreement.

Currently, a common technique for setting up and activating a wireless device includes providing a wired connection to a general purpose (e.g., home) computer, and performing device setup and/or activation via the home computer by means of one or more of installation media (e.g., CD-ROMS or other physical software media) and/or an Internet connection.

This technique does not, however, allow for a user to transfer settings directly from another wireless device to the wireless device, e.g., if the user is upgrading to a newer version of a similar type of device. Additionally, this technique is necessarily limited in flexibility and mobility by the typical requirements of a general purpose computer system, a wired connection thereto, and Internet connectivity via the general purpose computer. Accordingly, improvements in wireless device activation and setup would be desirable.

### SUMMARY

In light of the foregoing concerns, one possible improvement in wireless activation and setup might include providing a means for wireless devices to activate and/or perform device setup via a peer-to-peer connection with a peer device. For example, if the user has just acquired a new wireless device (e.g., a new smart phone), the user may wish to use the same configuration, settings, and data on the new wireless device as already exist on a previous wireless device (e.g., an older smart phone). By providing a direct peer-to-peer connection between the previous wireless device and the new wireless device, the configuration, settings, and data from the previous wireless device may be transferred directly to the new wireless device. This may represent a simpler, more efficient, and more flexible means of activating and setting up a wireless device, among other potential advantages which will become clear to those of skill in the art in light of this disclosure.

Accordingly, embodiments are presented herein of a method for activating and/or setting up a wireless user equipment (UE) device via a peer-to-peer link, and a UE configured to implement the method. The UE may include one or more radios, including one or more antennas, for performing wireless communications with base stations (BSs), and/or for performing peer-to-peer wireless communications. The UE may also include device logic (which may include a processor and memory medium and/or hardware logic) configured to implement the method. Embodiments are also presented of a memory medium (e.g., a non-transitory computer accessible memory medium) comprising program instructions executable by a processor to perform part or all of the method. The method may be performed as follows.

In some embodiments, the UE may provide a user interface. First user input may be received via the user interface. The first user input may include a request to perform device setup using a peer-to-peer wireless link.

In response to the first input, the UE may search for and discover a peer device via a peer-to-peer wireless communication protocol. The peer device may be a smart phone configured to perform cellular communication, a general purpose computer system, a tablet computer system, or any other type of device which is configured to perform peer-to-peer wireless communication.

The UE may also receive second user input via the user interface. The second user input may select the peer device with which to perform device setup and/or to activate the UE. The UE may establish a peer-to-peer link with the peer device using the peer-to-peer wireless communication protocol. The UE may establish the peer-to-peer link with the peer device in response to the second user input, or may do so automatically or in further response to the first user input.

The UE may be activated. Activating the UE may include provisioning the UE to communicate using a cellular communication network, in some embodiments. In one set of embodiments, the UE may activate itself via a wide-area network (WAN). For example, the UE may activate itself directly via a Wi-Fi connection to the Internet via a Wi-Fi access point.

Alternatively, activation of the UE may be facilitated by the peer device. For example, the UE may request, via the peer-to-peer wireless link, that the peer device activate the UE. The peer device may be configured to activate the UE via a WAN, based on the request that the peer device activate the UE. The peer device may be configured to communicate with the WAN via a cellular communication protocol (e.g., if a smart phone), and/or via any of a variety of other communication protocols. The peer device may provide an indication to the UE that the UE has been activated, and/or a cellular service provider may provide an indication to the UE that the UE has been activated (e.g., via a cellular communication protocol). In either case, the UE may receive an indication that it has been activated.

Device setup information for the UE may be requested from the peer device via the peer-to-peer wireless link. The device setup information may include a backup, e.g., a backup of the peer device (e.g., if the peer device is a similar class of device) or another device (e.g., a similar class of device for which the peer device stores a device backup).

Alternatively (e.g., if the UE has already undergone initial setup), the device setup information may include synchronization information, for synchronizing content and/or user settings between the peer device and the UE.

The device setup information may be received from the peer device via the peer-to-peer wireless link, and the UE may configure itself with the device setup information. If the device setup information is a device backup, configuring the UE with the device setup information may include restoring device settings (and/or content) to the UE from the device backup. If the device setup information is synchronization information, configuring the UE with the device setup information may include synchronizing user settings and/or data between the peer device and the UE.

As a further possibility, the device setup information may be a device backup, and the UE may perform a further series of steps to synchronize the UE with the peer device, e.g., based on any settings and/or content which may have been modified since the device backup was created or most recently updated. This may include requesting synchronization of the UE with the peer device via the peer-to-peer wireless link, receiving synchronization information from the peer device via the peer-to-peer wireless link, and configuring the UE with the synchronization information. The synchronization information may, in this case, include additional setup information and/or data for the UE.

After successfully configuring the UE with the device setup information and/or the synchronization information, the UE may provide an acknowledgement to the peer device via the peer-to-peer wireless link, if desired. The acknowledgement may confirm successful configuration of the UE with the device setup information and/or the synchronization information.

Embodiments are also presented herein of a method for a UE to facilitate setup and/or activation of a peer device via a peer-to-peer wireless link, and a UE configured to implement the method. The UE may include one or more radios, including one or more antennas, for performing wireless communications with base stations (BSs), and/or for performing peer-to-peer wireless communications. The UE may also include device logic (which may include a processor and memory medium and/or hardware logic) configured to implement the method. Embodiments are also presented of a memory medium (e.g., a non-transitory computer accessible memory medium) comprising program instructions executable by a processor to perform part or all of the method. The method may be performed as follows.

The UE may provide an indication of availability using a peer-to-peer wireless communication protocol. The indication of availability may be broad (e.g., may be provided to all devices within communicative range of the UE) or narrow (e.g., may be directed only to specific devices).

The UE may establish a peer-to-peer wireless link with a peer device using the peer-to-peer wireless communication protocol.

The UE may receive a request to activate the peer device via the peer-to-peer wireless link. In response, the UE may activate the peer device, e.g., via a WAN. For example, the UE may activate the peer device via a cellular communication protocol in communication with a cellular service provider's network and/or the Internet. If the activation is successful, the UE may provide an acknowledgement or other indication that the activation was successful.

Additionally, or alternatively, a request for device setup information may be received from the peer device via the peer-to-peer wireless link. The requested device setup information might include a device backup of the UE, or synchronization information for synchronizing content and/or settings between the UE and the peer device. The UE may provide the device setup information to the peer device via the peer-to-peer wireless link.

The UE may also receive an acknowledgement confirming that the peer device has successfully configured the peer device using the device setup information.

It should be noted that although the above-described methods for activating and/or setting up a UE device via a peer-to-peer link and for facilitate setup and/or activation of a peer device via a peer-to-peer wireless link are described separately, it is possible that part or all of the methods may be used in conjunction with each other, e.g., by two peer UEs.

### BRIEF DESCRIPTION OF THE DRAWINGS

A better understanding of the present subject matter can be obtained when the following detailed description of the preferred embodiment is considered in conjunction with the following drawings, in which:

FIG. 1 illustrates an exemplary (and simplified) wireless communication system;

FIG. 2 illustrates a base station in communication with user equipment;

FIG. 3 illustrates an exemplary block diagram of a UE;

FIGS. 4-5 are flowchart diagrams illustrating methods for setting up a UE via a peer-to-peer wireless link; and

FIG. 6 is a diagram illustrating an exemplary peer-to-peer communication flow between devices.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

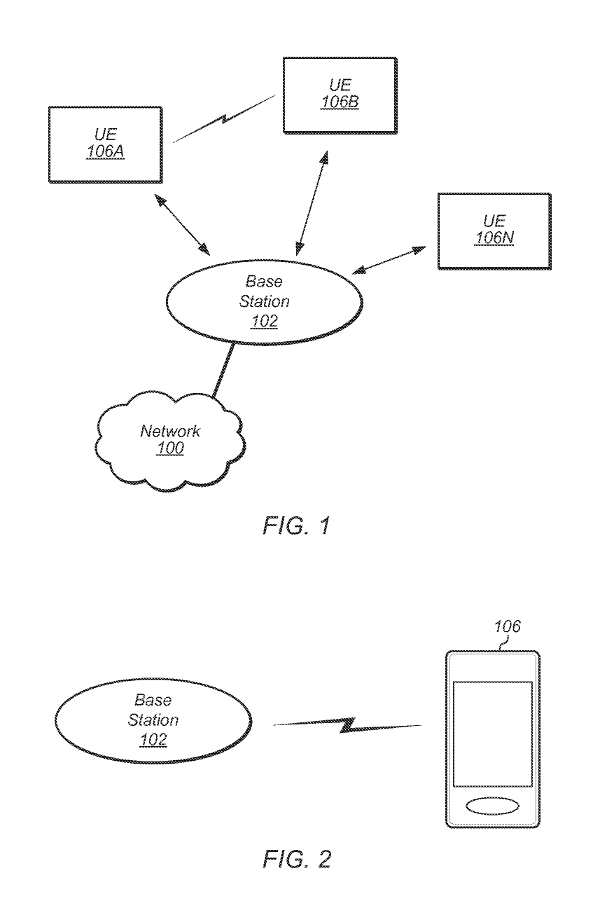

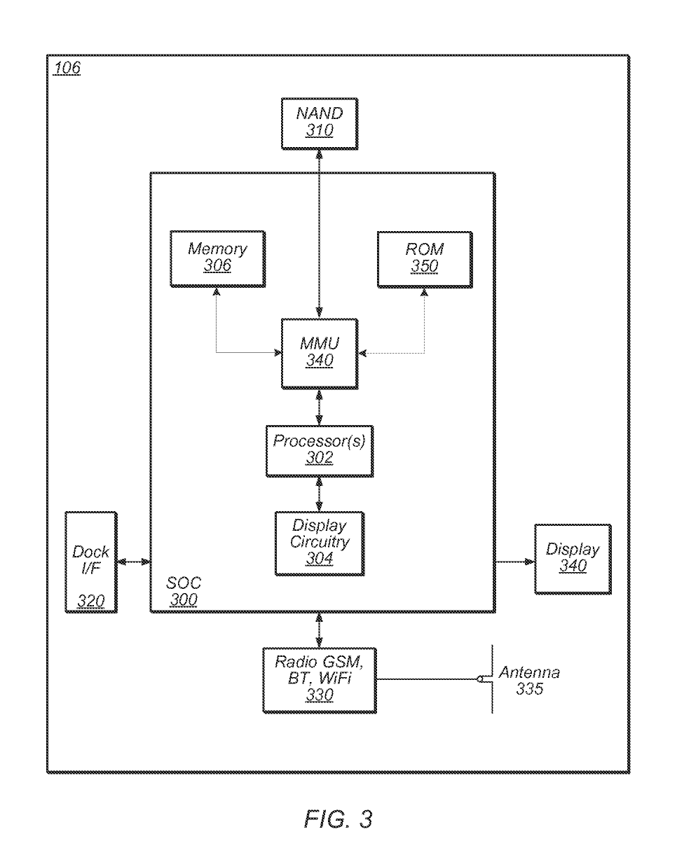

### FIGS. 1-2—Communication System

FIG. 1 illustrates an exemplary (and simplified) wireless communication system. It is noted that the system of FIG. 1 is merely one example of a possible system, and embodiments may be implemented in any of various systems, as desired.

As shown, the exemplary wireless communication system includes a base station 102 which communicates over a transmission medium with one or more user devices 106-1 through 106-N. Each of the user devices may be referred to herein as a “user equipment” (UE). Thus, the user devices are referred to as UEs or UE devices.

The base station 102 may be a base transceiver station (BTS) or cell site, and may include hardware that enables wireless communication with the UEs 106A through 106N according to a cellular communication protocol. Alternatively, the base station 102 may be an access point providing a wireless local area network (WLAN). The base station 102 may be equipped to communicate with a network 100, such as a cellular service provider's network and/or the Internet. Thus, the base station 102 may facilitate communication between the UEs and/or between the UEs and the network 100. The base station 102 and the UEs may be configured to communicate over the transmission medium using any of various wireless communication technologies such as GSM, CDMA, WLL, WAN, WiFi, WiMAX, etc.

As shown, in some embodiments multiple UEs 106 may be configured to communicate directly with each other, e.g., using a peer-to-peer wireless communication protocol. For example, Bluetooth (“BT”, including BT low energy (“BLE”), Alternate MAC/PHY (“AMP”), and/or other BT versions or features), Wi-Fi ad-hoc/peer-to-peer, and/or any other peer-to-peer wireless communication protocol may be used to facilitate direct communications between two UEs 106.

UE 106 may be capable of communicating using multiple wireless communication standards. For example, in some embodiments, the UE 106 may be configured to communicate using at least one peer-to-peer wireless communication protocol (e.g., BT, Wi-Fi peer-to-peer, etc.) and at least one cellular communication protocol (e.g., UMTS, LTE, 1xRTT, etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106-1 through 106-N) in communication with the base station 102. The UE 106 may be a device with wireless network connectivity such as a mobile phone, a hand-held device, a computer or a tablet, or virtually any type of wireless device.

The UE may include a processor that is configured to execute program instructions stored in memory. The UE may perform any of the methods embodiments described herein by executing such stored instructions. Alternatively, or in addition, the UE may include a programmable hardware element such as an FPGA (field-programmable gate array) that is configured to perform any of the method embodiments described herein, or any portion of any of the method embodiments described herein.

The UE 106 may be configured to communicate using any of multiple wireless communication protocols. For example, the UE 106 may be configured to communicate using one or more of CDMA 2000, LTE, WLAN, or BT. Other combinations of wireless communication standards are also possible.

The UE 106 may include one or more antennas for communicating using one or more wireless communication protocols. The UE 106 may share one or more parts of a receive and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios which are shared between multiple wireless communication protocols, and one or more radios which are used exclusively by a single wireless communication protocol. For example, in one set of embodiments, the UE 106 may include a shared radio for communicating using either of LTE or 1xRTT, and separate radios for communicating using each of Wi-Fi and Bluetooth. Other configurations are also possible.

It is possible that the UE 106 may require activation prior to being provided with cellular communication service (e.g., telecommunication and/or data services) via the base station 102. For example, the user's service provider may require that the user provide device-specific information (e.g., a device serial number) to be associated with that user's account thenceforth. Other information may also or alternatively be required for activation, and/or other forms of activation may be required.

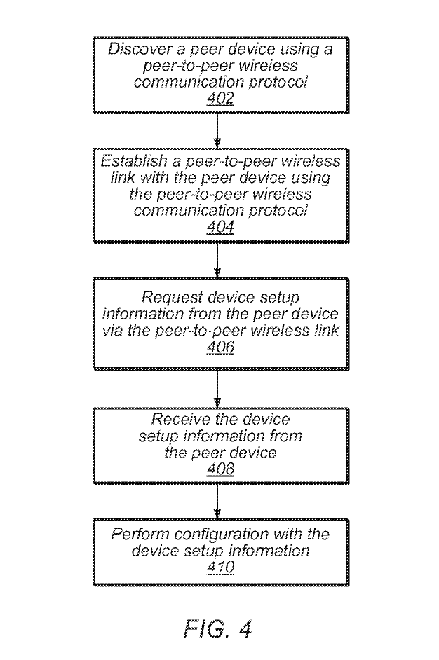

### FIG. 3—Exemplary Block Diagram of a UE

FIG. 3 illustrates an exemplary block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 340. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 340. The MMU 340 may be configured to perform memory protection and page table translation or set up. In some embodiments, the MMU 340 may be included as a portion of the processor(s) 302.

As shown in FIG. 3, ROM 350 may include a bootloader, which may be executed by the processor(s) 302 during boot up or initialization. As also shown, the SOC 300 may be coupled to various other circuits of the UE 106. For example, the UE 106 may include various types of memory (e.g., including NAND flash 310), a connector interface 320 (e.g., for coupling to the computer system), the display 340, and wireless communication circuitry (e.g., for LTE, CDMA2000, Bluetooth, WiFi, etc.).

The UE device 106 may include at least one antenna, and possibly multiple antennas, for performing wireless communication with base stations and/or other devices. For example, the UE device 106 may use antenna 335 to perform the wireless communication. As noted above, the UE may be configured to communicate wirelessly using multiple wireless communication standards.

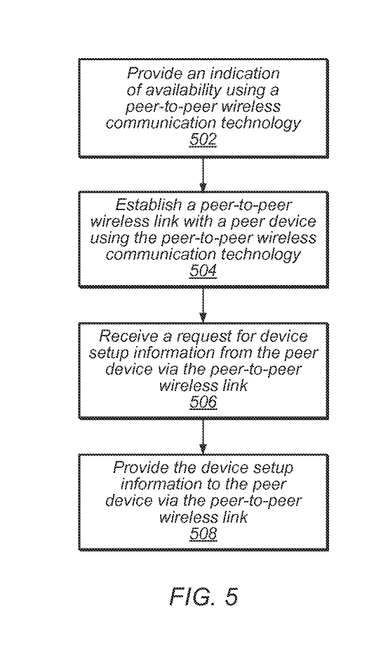

As described herein, the UE 106 may include hardware and software components for implementing a method for activating and setting up the UE 106 via a peer-to-peer link according to embodiments of this disclosure. FIG. 4 and the description provided with respect thereto relate to one such method.

The processor 302 of the UE device 106 may be configured to implement part or all of the methods described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit).

### FIGS. 4-5—Flowcharts

Currently, it is common that when a user buys a new UE (such as UE 106), such as a smart phone, tablet, portable media player, etc., that user is required to activate and/or configure the new UE before using it. For example, before the user may utilize a UE's cellular communication capability, the user may be required to purchase telecommunication service (e.g., a voice, SMS, and/or data plan) from a cellular service provider and activate the UE with the cellular service provider in conjunction with the purchased service. Activation may also include some device configuration, in some cases; for example, some UEs may include certain hardware features which require configuration (e.g., drivers may need to be installed) before they are fully functional, which may be performed as part of activation and/or as a separate configuration process according to various embodiments.

To activate and/or configure the UE, the user may have certain options. One common option is to provide a wired connection (such as USB) to a general purpose computing system (e.g., their home computer) and activate/configure via the general purpose computing system's Internet connection. This may be done in conjunction with an activation application provided on a software medium (e.g., a CD-ROM) and/or on the user's general purpose computing system. For example, an iPhone™ user might activate and configure their new iPhone™ by connecting to an iTunes™ application on their home computer via a USB cable.

It is common for a user with a new UE to have one or more other UEs as well. For example, a user with a new iPhone™ might have an older version of the iPhone™, an iPad™, and/or one or more other UEs. As such, it may be desirable for the user to be able to transfer or synchronize settings and/or data from an older UE to a new UE, or more generally from one UE to another UE. For example, the user may want their new UE to include the same device settings (e.g., clock, user interface appearance, etc), contacts, music, photos, videos, applications, application settings, and/or other settings as another UE device which they have already setup according to their preferences.

This can be done via a wired connection to a general purpose computing system, at least in some embodiments. For example, according to some embodiments, a UE might be configured by a home computer which stores a backup of another UE, by restoring the UE using the stored backup.

However, it has not previously been possible to obtain device setup information for a UE directly from another UE, and particularly not via a peer-to-peer wireless link. Nor has it been possible to obtain device setup information for a UE directly from a general purpose computer via a peer-to-peer wireless link. Providing such a capability would greatly improve the flexibility, efficiency, and simplicity of activation/setup of a new UE for a user, as the user would not have to go through a multi-step process of backing up another UE to a computer, providing a wired connection between the new UE and the computer, and performing a restore of the backup of the other UE from the computer to the new UE, but could instead simply acquire device setup information directly from the other UE without requiring any wiring or intermediary computer system, router, or other device.

Accordingly, certain embodiments of the present disclosure relate to a method for a UE device to perform device activation and/or setup via a peer-to-peer link. FIGS. 4-5 are flowchart diagrams illustrating such a method. The methods shown in FIGS. 4-5 may be used in conjunction with any of the computer systems or devices shown in the above Figures, among other devices. Some of the method elements shown may be performed concurrently, in a different order than shown, or may be omitted. Additional method elements may also be performed as desired.

FIG. 4 relates, in particular, to a method for setting up a UE via a peer-to-peer wireless link. The method may be performed by the UE itself. As noted above, the UE may be any of a variety of devices. A common example may include a smart phone, e.g., which is configured for wireless communication according to one or more cellular communication protocols (e.g., UMTS, LTE, and/or CDMA2000), Wi-Fi, and Bluetooth, and which is configured to execute a mobile operating system such as iOS™ or Android™. Of course, the UE may alternatively be any of a variety of other types of device, as desired, including but not limited to tablet computers, e-readers, portable multimedia players, portable gaming systems, and/or other cellular devices. As shown, the method may operate as follows.

The UE may provide a user interface. For example, the UE may include one or more of a display (which may be a touch-screen display capable of receiving user input), one or more buttons, a keyboard or keypad, a mouse or other pointer device, speakers, microphone, camera, and/or any of a variety of other components which may be operable to present user options and/or receive user input. The user interface may be an initial device setup interface, for guiding the user through the process of activating and initially configuring the UE. Alternatively, or in addition, the user interface may be part of the normal operating environment (e.g., as configured) of the UE; for example, the user interface may be a “configuration” or “settings” menu reached from a home screen of the UE. Other types of user interfaces are also possible.

First user input may be received via the user interface. The first user input may include a request to perform device setup using a peer-to-peer wireless link. For example, if the user interface is an initial device setup interface, the UE might provide options for performing initial activation and setup, which might include, among other possible options, connecting the UE to a computer via a USB or other wired connection or performing device setup wirelessly. The first user input might include input to a touch-screen or other button, a mouse click, audio (e.g., vocal) input, a touch-screen or mouse-based gesture, or any other type of user input.

The UE may search for a peer device via a peer-to-peer wireless communication protocol. The UE may perform the search in response to the first user input, or in some cases, automatically. For example, the UE may automatically search for available devices which may be used to facilitate activation and/or setup via the peer-to-peer wireless communication protocol. The peer-to-peer wireless communication protocol may be any of a variety of peer-to-peer wireless communication protocols. Note that a peer-to-peer wireless communication protocol may be a wireless communication protocol by means of which two devices may interact directly via a wireless link without requiring any intermediary devices (such as routers, access points, gateways, base stations, etc.). Examples of peer-to-peer wireless communication protocols include Wi-Fi peer-to-peer and Bluetooth (according to any of various Bluetooth versions, including Bluetooth LE). Other peer-to-peer wireless communication protocols may be used in addition or alternatively as desired. If desired, the UE may search for peer devices via multiple wireless communication protocols. For example, some peer devices might be available via Bluetooth but not Wi-Fi peer-to-peer, while other peer devices might be available via Wi-Fi peer-to-peer but not Bluetooth. Thus, if the UE is capable of searching using multiple peer-to-peer wireless communication protocols, this may provide more flexibility, for example, allowing the UE to work with devices which are only configured to communicate using one peer-to-peer wireless communication protocol.

In 402, the UE may discover the peer device using a peer-to-peer wireless communication protocol. The peer device may be a smart phone configured to perform cellular communication, a general purpose computer system, a tablet computer system, or any other type of device which is configured to perform peer-to-peer wireless communication, according to various embodiments. In some embodiments, it may be particularly useful if the peer device is a device which is a similar class of device as the UE, such that more of the settings/configuration of the peer device may be used to set up/configure the UE. For example, if the peer device is a smart phone, and the UE is also a smart phone, in some cases a backup of the peer device may be “restored” to the UE, as they may be compatible. However, the peer device may be a different class of device than the UE if desired; for example, the UE may be a smart phone while the peer device may be a general purpose computer, or another class of device.

The UE may also receive second user input via the user interface. The second user input may select the peer device with which to perform device setup and/or to activate the UE. For example, after discovering the peer device (and possibly one or more other peer devices), the UE may provide a menu presenting any peer devices found using peer-to-peer wireless communication protocols, from which the user may select the peer device with which it is desired to perform activation and/or device setup.

In 404, the UE may establish a peer-to-peer link with the peer device using the peer-to-peer wireless communication protocol. The UE may establish the peer-to-peer link with the peer device in response to the second user input, automatically, or in further response to the first user input, among various possibilities.

The UE may be activated. Activating the UE may include provisioning the UE to communicate using a cellular communication network, in some embodiments. The UE may activate itself via a wide-area network (WAN). For example, the UE may activate itself via a Wi-Fi connection to the Internet via a Wi-Fi access point.

Alternatively, activation of the UE may be facilitated by the peer device. For example, in a situation in which no Wi-Fi access point with an Internet connection is available, the UE may not be able to activate itself using Wi-Fi. Furthermore, some UEs may not be configured to communicate with Wi-Fi, or may have limited or no ability to communicate with Wi-Fi prior to activation and/or device setup. In such cases, it may be desirable to use a cellular or other wireless communication capability of the peer device to access a network (e.g., through the Internet and/or a cellular service provider's network) in order to activate the UE.

Thus, the UE may request, via the peer-to-peer wireless link, that the peer device activate the UE. The peer device may be configured to activate the UE via a wide area network (WAN), based on the request that the peer device activate the UE. The peer device may be configured to communicate with the WAN via a cellular communication protocol (e.g., if a smart phone or other cellular communication enabled device), and/or via any of a variety of other communication protocols. In some embodiments, activation may include providing information (e.g., device identification information, personal/user account information, etc.) to a service provider via the WAN; the information may be provided to the UE, which may be communicated to the peer device via the peer-to-peer wireless link, and thence to the service provider via the peer device's WAN link.

In some embodiments, the peer device may provide an indication to the UE that the UE has been activated. Alternatively, or in addition, a cellular service provider may provide an indication to the UE that the UE has been activated (e.g., via a cellular communication protocol). Thus, the UE may receive an indication that it has been activated.

In 406, device setup information for the UE may be requested from the peer device via the peer-to-peer wireless link. The device setup information may include a device backup, e.g., a backup of the peer device (e.g., if the peer device is a similar class of device) or another device (e.g., a similar class of device for which the peer device stores a device backup). A device backup may include an image of the contents of the device, potentially including some or all of a configured operating system, configuration settings for the device, device content (e.g., contact information, audio files, video files, e-books, applications, application settings, etc.), and/or other possible information, such as metadata describing the contents of the device backup. The device backup may be in a format that provides for the information included in the backup to be “restored” to the device from which it was created or another compatible device, such that after restoring the backup to the target device, the target device may be configured with the same operating system, configuration settings, device content, etc., of the device from which the backup was made at the time of the backup. The device backup may include a single file, or multiple files, among various possibilities.

Alternatively, or in addition, the device setup information may include synchronization information, for synchronizing content and/or user settings between the peer device and the UE. For example, in some cases a user may want to synchronize content (e.g., music, videos, and/or e-books) and/or applications between multiple devices; this may be desirable, for example, if the user has purchased some or all of the content and wants to be able to access the content on all of their compatible devices. The peer-to-peer wireless link may thus advantageously be used for such purposes even if the UE has already been activated and initially configured. The synchronization information may thus include various content items and possibly user settings and/or configuration information (e.g., if the user has changed settings on one device and wants the settings changes carried over to the other device). The synchronization information may also include information indicating content items to delete (e.g., if the user has deleted content on one device and wants the deletion(s) carried over to the other device).

In 408, the device setup information may be received from the peer device via the peer-to-peer wireless link.

In 410, the UE may configure itself with the device setup information. If the device setup information includes a device backup, configuring the UE with the device setup information may include restoring device settings and/or content to the UE from the device backup. If the device setup information includes synchronization information, configuring the UE with the device setup information may include synchronizing user settings and/or data between the peer device and the UE, which may include adding and/or deleting content and/or modifying device settings.

In some cases, the device setup information may include only a device backup, and the UE may perform a further series of steps to synchronize the UE with the peer device in addition to the initial activation and setup, e.g., based on any settings and/or content which may have been modified since the device backup was created or most recently updated. This may include requesting synchronization of the UE with the peer device via the peer-to-peer wireless link, receiving synchronization information from the peer device via the peer-to-peer wireless link, and configuring the UE with the synchronization information. The synchronization information may, in this case, include additional setup information and/or data for the UE, such as in a similar manner as described above.

If desired, after successfully configuring the UE with the device setup information and/or the synchronization information, the UE may provide an acknowledgement to the peer device via the peer-to-peer wireless link. The acknowledgement may confirm successful configuration of the UE with the device setup information and/or the synchronization information.

FIG. 5 relates to a method for a UE to facilitate setup and/or activation of a peer device via a peer-to-peer wireless link. The method may be performed by the UE itself. Note that the method of FIG. 5 may be complementary to the method of FIG. 4. For example, the peer device described with respect to FIG. 4 may be the UE implementing the method of FIG. 5, while the UE implementing the method of FIG. 4 may be the peer device of the UE implementing the method of FIG. 5. As shown, the method may operate as follows.

In 502, the UE may provide an indication of availability using a peer-to-peer wireless communication protocol. The indication of availability may be broad (e.g., may be provided to all devices within communicative range of the UE) or narrow (e.g., may be directed only to specific devices). The UE may provide the indication of availability in response to user input indicating that the UE should provide an indication of availability using a peer-to-peer wireless communication protocol. For example, the user may configure the UE to provide a “personal hotspot”, such that other of the user's devices and/or devices given permission by the user may be able to discover and connect to the UE via the peer-to-peer wireless communication protocol. Alternatively, or in addition, the UE may be instructed to advertise its availability specifically for the purpose of facilitating activation and/or setup of a peer device, e.g., if the user knows that they want to use the UE to facilitate such activation and/or setup.

In 504, the UE may establish a peer-to-peer wireless link with a peer device using the peer-to-peer wireless communication protocol. The UE may have received a request from the peer device to establish the peer-to-peer wireless link, in some embodiments. For example, the peer device may request, using the peer-to-peer wireless communication protocol, that the peer-to-peer wireless link be established in order to facilitate device activation and/or setup of the peer device. The peer-to-peer wireless communication protocol may be any of a variety of peer-to-peer wireless communication protocols, including Bluetooth, Wi-Fi peer-to-peer, or others.

The UE may receive a request to activate the peer device via the peer-to-peer wireless link. In response, the UE may activate the peer device, e.g., via a WAN. For example, the UE may activate the peer device via a cellular communication protocol in communication with a cellular service provider's network and/or the Internet. If the activation is successful, the UE may provide an acknowledgement or other indication that the activation was successful.

In 506, a request for device setup information may be received from the peer device via the peer-to-peer wireless link. The requested device setup information might include a device backup of the UE, and/or synchronization information for synchronizing content and/or settings between the UE and the peer device.

In 508, the UE may provide the device setup information to the peer device via the peer-to-peer wireless link. The provided device setup information may enable the peer device to configure itself and/or synchronize its content and/or settings with the UE, such as described with respect to FIG. 4.

The UE may also receive an acknowledgement confirming that the peer device has successfully configured the peer device using the device setup information.

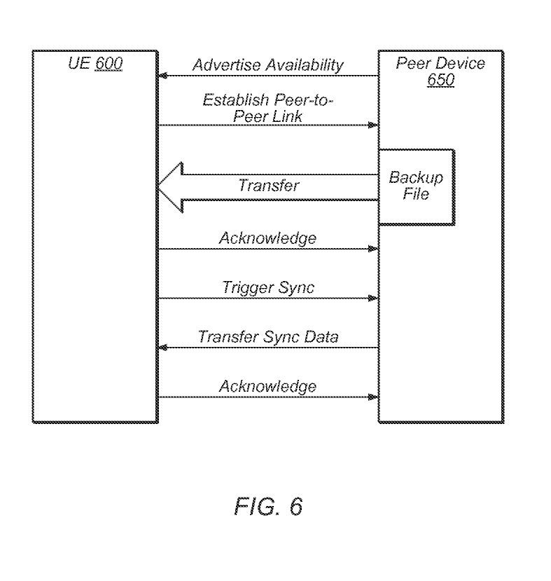

### FIG. 6—Communication Diagram

FIG. 6 is a diagram illustrating an exemplary communication flow in a peer-to-peer activation and setup. FIG. 6 and the following description provided with respect thereto are provided by way of example as one possible way of implementing the methods of FIGS. 4-5, but it will be recognized that numerous variations and alternatives thereto are also possible and should be considered within the scope of this disclosure. Accordingly, FIG. 6 and the following description provided with respect thereto should not be considered limiting to the disclosure as a whole.

As shown, there may be a UE 600 and a peer device 650. The UE 600 may be a smart phone, tablet, or any other wireless device configured to perform peer-to-peer wireless communication. The peer device 650 may also be any of various types of devices configured to perform peer-to-peer wireless communication. In some embodiments, the peer device 650 may be a similar class of device as the UE 600, while in other embodiments, the peer device 650 may be a different class of device than the UE 600.

The peer device 650 may initially advertise its availability using one or more peer-to-peer wireless communication protocols. The UE 600 may discover the peer device 650 and establish a peer-to-peer link with the peer device 650, possibly in response to user input indicating to the UE 600 to establish the peer-to-peer link with the peer device 650.

The peer device 650 may transfer a backup file (which may be a backup of the peer device 650, or a backup of another device) to the UE 600. The UE 600 may install the backup file to the UE 600, thereby configuring itself according to the settings and data included in the backup file. The UE 600 may then provide an acknowledgement to the peer device 650, that the transfer and installation (“restore”) of the backup was successful.

Possibly immediately, or possibly at a later time, synchronization between the UE 600 and the peer device 650 may be triggered. For example, a user may configure the UE 600 to synchronize some or all of its content and/or settings with the peer device 650. The user may configure the UE 600 to do so as a one-time command, or may configure the UE 600 to automatically synchronize with the peer device 650 (e.g., at regular intervals, and/or when available) via a peer-to-peer wireless communication protocol.

Once the UE 600 has been triggered to sync with the peer device 650, the peer device 650 may transfer synchronization information to the UE 600 via a peer-to-peer wireless link (e.g., the same peer-to-peer wireless link as previously established, or possibly a new peer-to-peer wireless link if synchronization is performed at a later time). The UE 600 may then utilize the synchronization data to synchronize its settings and/or data with the peer device 650 according to the synchronization information, and send an acknowledgement to the peer device 650 via the peer-to-peer wireless link indicating that the synchronization was successful.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for setting up a wireless user equipment (UE) device via a peer-to-peer wireless link, the method comprising:
discovering a peer device using a peer-to-peer wireless communication protocol;
establishing a peer-to-peer wireless link with the peer device using the peer-to-peer wireless communication protocol;
requesting device setup information for the UE from the peer device via the peer-to-peer wireless link;
receiving the device setup information from the peer device via the peer-to-peer wireless link; and
configuring the UE with the device setup information.

2. The method of claim 1,
wherein the device setup information is a device backup, wherein configuring the UE with the device setup information comprises restoring device settings from the device backup.

3. The method of claim 2,
wherein the device backup is a backup of the peer device.

4. The method of claim 1, the method further comprising:
requesting synchronization of the UE with the peer device via the peer-to-peer wireless link;
receiving synchronization information from the peer device via the peer-to-peer wireless link, wherein the synchronization information comprises additional setup information and/or data for the UE;
configuring the UE with the synchronization information.

5. The method of claim 1,
wherein the device setup information is synchronization information configured to synchronize user settings and/or data between the peer device and the UE.

6. The method of claim 1,
wherein the peer device is configured to communicate with a wide area network (WAN), the method further comprising:
requesting, via the peer-to-peer wireless link, that the peer device activate the UE;
wherein the peer device is configured to activate the UE via the WAN based on the request that the peer device activate the UE.

7. The method of claim 6,
wherein the peer device is configured to communicate with the WAN via a cellular communication protocol.

8. The method of claim 1, the method further comprising:
providing a user interface;
receiving first user input via the user interface, wherein the first user input comprises a request to perform device setup and/or activation via a peer-to-peer wireless link.

9. The method of claim 8,
wherein said discovering the peer device via the peer-to-peer wireless communication protocol is performed based on the first user input.

10. The method of claim 8, the method further comprising:
receiving second user input via the user interface, wherein the second user input selects the peer device with which to perform the device setup and/or activation.

11. The method of claim 1, the method further comprising:
providing an acknowledgement to the peer device via the peer-to-peer wireless link, wherein the acknowledgement confirms successful configuration of the UE with the device setup information.

12. The method of claim 1, the method further comprising:
activating the UE via a wide area network, wherein activating the UE provisions the UE to communicate using a cellular communication network.

13. The method of claim 1,
wherein the peer device is a smart phone configured to perform cellular communication.

14. The method of claim 1,
wherein the peer device is a general purpose computing system.

15. A user equipment (UE) device, comprising:
a radio, comprising one or more antennas for performing wireless communication;
a processor;
a computer accessible memory medium comprising program instructions executable by the processor to:
provide a user interface;
receive first user input via the user interface, wherein the first user input comprises a request to perform device setup using a peer-to-peer wireless link;
search for and discover a peer device using a peer-to-peer wireless communication protocol in response to the first user input;
establish a peer-to-peer wireless link with a peer device using the peer-to-peer wireless communication protocol;
request device setup information for the UE from the peer device via the peer-to-peer wireless link;
receive the device setup information from the peer device via the peer-to-peer wireless link; and
configure the UE with the device setup information.

16. The UE of claim 15, wherein the program instructions are further configured to:
receive second user input via the user interface, wherein the second user input selects the peer device with which to perform the device setup;
wherein establishing the peer-to-peer link, requesting device setup information, receiving the device setup information, and configuring the UE are performed in response to the second user input.

17. The UE of claim 15, wherein the device setup information comprises a device backup of the peer device, wherein the program instructions are further configured to:
synchronize the UE with the peer device via the peer-to-peer wireless link after configuring the UE with the device backup of the peer device.

18. The UE of claim 15, wherein the device setup information comprises one or more of:
hardware configuration information;
an application;
user-generated data; or
media content.

19. A non-transitory computer accessible memory medium comprising program instructions for activating a user equipment (UE) device via a peer-to-peer wireless link, wherein the program instructions are executable to:
discover a peer device using a peer-to-peer wireless communication protocol;
establish a peer-to-peer wireless link with the peer device using the peer-to-peer wireless communication protocol;
request, via the peer-to-peer wireless link, that the peer device activate the UE, wherein the peer device is configured to activate the UE via a wide area network based on the request that the peer device activate the UE; and
receive an indication that the UE has been activated.

20. The memory medium of claim 19, wherein the program instructions are further executable to:
request device setup information for the UE from the peer device via the peer-to-peer wireless link;
receive the device setup information from the peer device via the peer-to-peer wireless link; and
configure the UE with the device setup information.

21. A method for a wireless user equipment (UE) device to facilitate setup of a peer device via a peer-to-peer wireless link, the method comprising:
providing an indication of availability using a peer-to-peer wireless communication protocol;
establishing a peer-to-peer wireless link with a peer device using the peer-to-peer wireless communication protocol;
receiving a request for device setup information from the peer device via the peer-to-peer wireless link; and
providing the device setup information to the peer device via the peer-to-peer wireless link.

22. The method of claim 21, the method further comprising:
receiving a request to activate the peer device via the peer-to-peer wireless link; and
activating the peer device via a wide area network.

23. The method of claim 22, the method further comprising:
providing an indication that the peer device has been activated to the peer device via the peer-to-peer wireless link.

24. The method of claim 21, the method further comprising:
receiving an acknowledgement confirming that the peer device has successfully configured the peer device using the device setup information.

25. A non-transitory computer accessible memory medium comprising program instructions for a user equipment (UE) device to activate a peer device, wherein the program instructions are executable to:
establish a peer-to-peer wireless link with the peer device using a peer-to-peer wireless communication protocol;
receive a request, via the peer-to-peer wireless link, that the UE activate the peer device;
activate the peer device via a wide area network.

26. The memory medium of claim 25,
wherein activating the peer device provisions the peer device to communicate using cellular communication with service provided by a cellular service provider;
wherein the program instructions are executable to activate the peer device via cellular communication, wherein the wide area network comprises a core network of the cellular service provider.
